(19) United States
(12) Patent Application Publication
(10) Pub. No.: US 2015/0027966 A1
(43) Pub. Date: Jan. 29, 2015

(54) SUPPORTING APPARATUS FOR ELECTROSTATIC GUN

(71) Applicant: HON HAI PRECISION INDUSTRY CO., LTD., New Taipei (TW)

(72) Inventor: CHIH-HAO LIN, New Taipei (TW)

(73) Assignee: HON HAI PRECISION INDUSTRY CO., LTD., New Taipei (TW)

(21) Appl. No.: 13/966,263

(22) Filed: Aug. 13, 2013

(30) Foreign Application Priority Data
Jul. 26, 2013 (TW) 102126871

(51) Int. Cl. F16M 13/00

(52) U.S. Cl. CPC F16M 13/00
USPC 211/13.1

(57) ABSTRACT

An electrostatic gun supporting apparatus includes a bracket and a positioning assembly. The bracket includes a bottom plate and two supporting plates extending up from two opposite sides of the bottom plate. The positioning assembly includes a positioning plate for mounting an electrostatic gun, and two pins protruding out from two opposite sides of the positioning plate. The supporting plates define two opposite guiding portions. Each guiding portion includes a number of guiding slots. The guiding slots are parallel to and spaced from one another. The guiding slots of each guiding portion are arrayed from up to bottom. The guiding slots of each guiding portion are communicated with one another. The pins of the positioning assembly can be slidably received in two corresponding guiding slots.

### BACKGROUND

1. Technical Field

The present disclosure relates to a supporting apparatus for mounting an electrostatic gun.

2. Description of Related Art

An electrostatic gun is generally used to test static electricity of metal chassis by an operator holding the electrostatic gun. However, if the operator needs to hold the electrostatic gun for a long time, the operator is easily tired, thus test precision may be decreased.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a supporting apparatus.

FIG. 2 is similar to FIG. 1, but viewed from another perspective.

FIG. 3 is an assembled, isometric view of FIG. 1.

FIG. 4 is similar to FIG. 3, but shows the supporting apparatus in use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

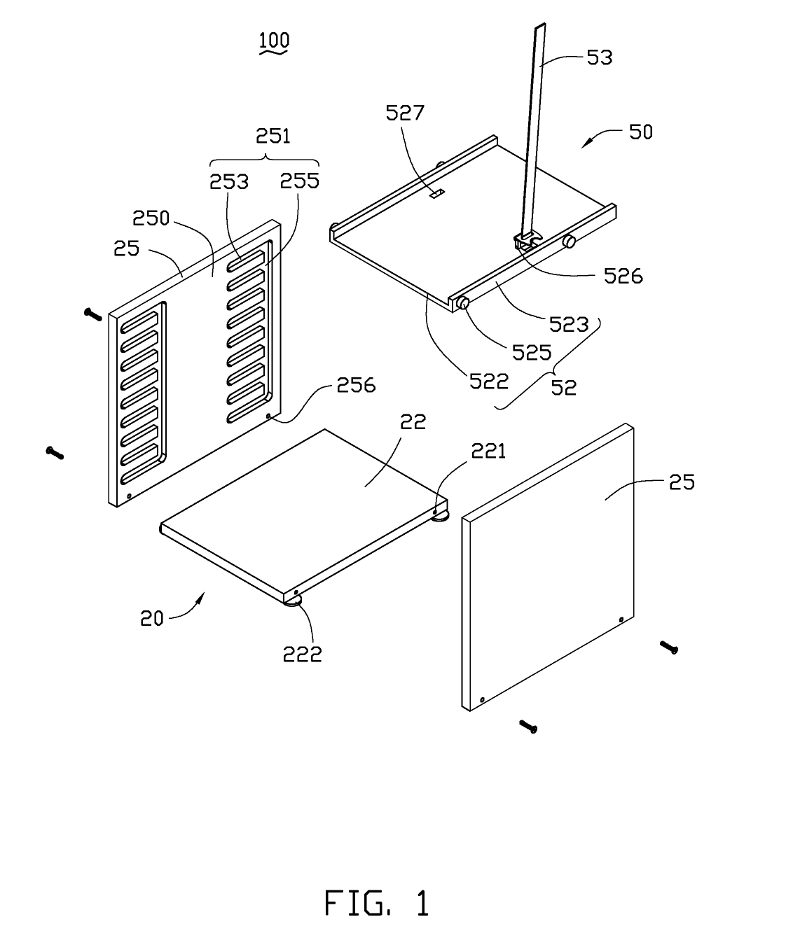

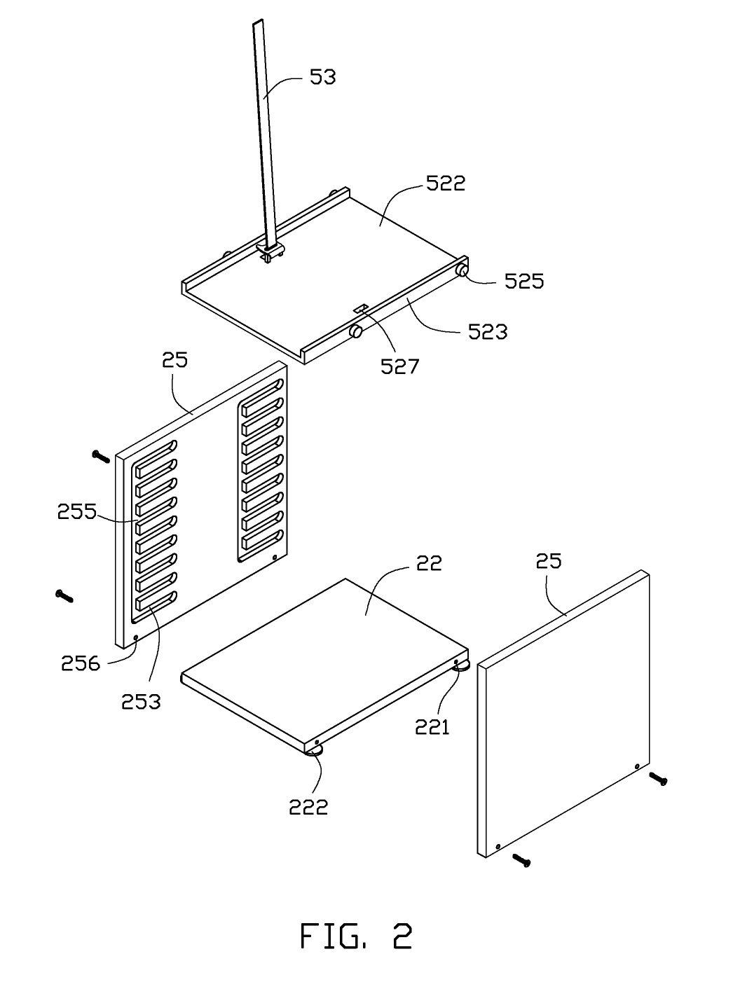

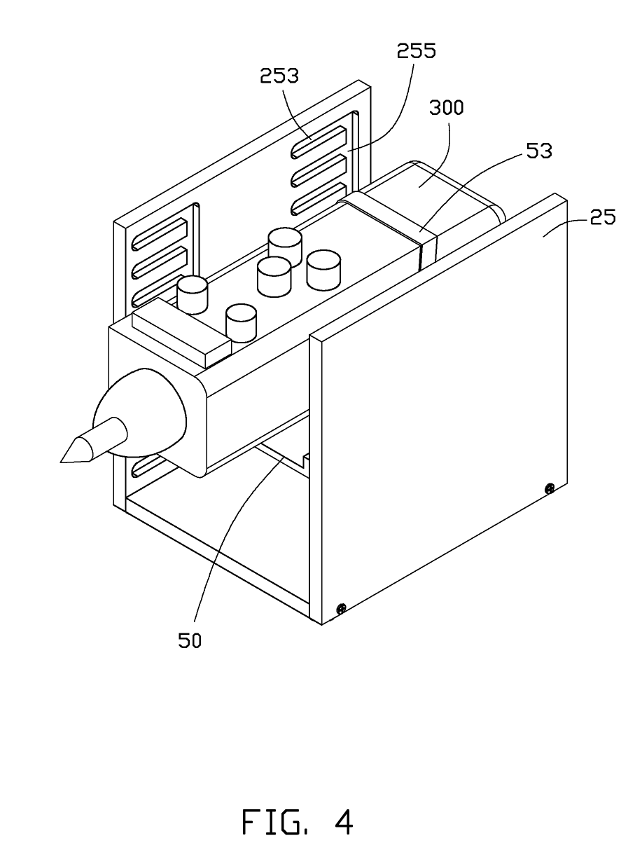

FIGS. 1 and 2 show an embodiment of a supporting apparatus 100 for mounting an electrostatic gun 300 (shown in FIG. 4). The supporting apparatus 100 includes a bracket 20 and a positioning assembly 50.

The bracket 20 includes a substantially rectangular bottom plate 22 and two supporting plates 25. Four feet 222 are mounted on four corners of a bottom surface of the bottom plate 22, for supporting the bottom plate 22. Two opposite sides of the bottom plate 22 define a plurality of screw holes 221. Each supporting plate 25 is substantially rectangular, and includes an inner surface 250. Two opposite sides of the inner surface 250 define two guiding portions 251. Each guiding portion 251 includes a plurality of parallel to and spaced guiding slots 253 and a connecting slot 255 positioned at a rear side of the guiding slots 253. The guiding slots 253 of each guiding portion 251 are arrayed from top to bottom. The connecting slot 255 communicates with the corresponding guiding slots 253. A lower portion of the supporting plate 25 defines a plurality of through holes 256.

The positioning assembly 50 includes a mounting member 52 and a band 53. The mounting member 52 includes a rectangular positioning plate 522, two flanges 523 perpendicularly extending up from two opposite sides of the positioning plate 522, and two pins 525 protruding out from two opposite ends of each flange 523. A substantially U-shaped connecting portion 526 perpendicularly extends up from a middle of one side of the positioning plate 522. A middle of the other side of the positioning plate 522 defines a latching hole 527 opposite to the connecting portion 526. A first end of the band 53 is mounted to the connecting portion 526.

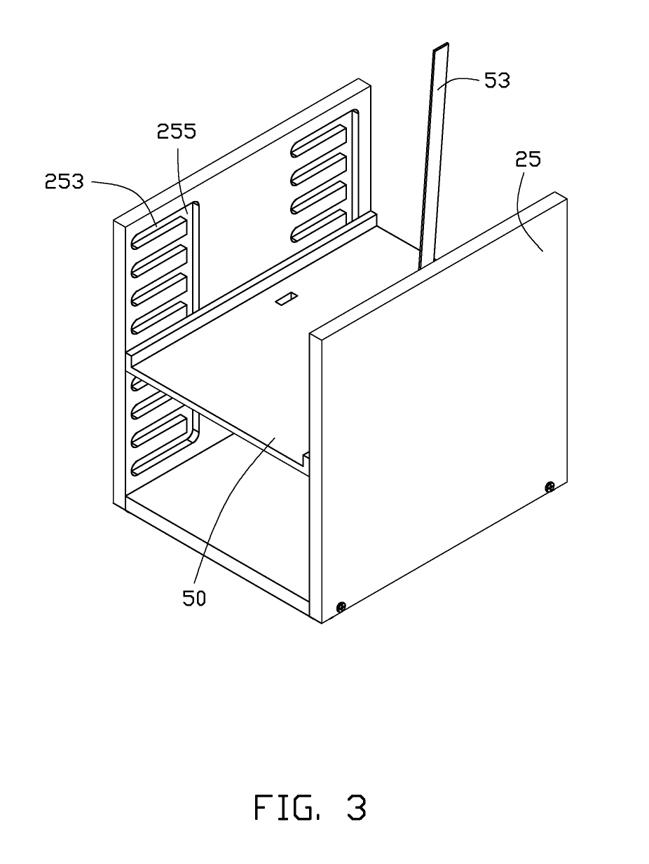

FIG. 3 shows that in assembling of the supporting apparatus 100, the bottom plate 22 is sandwiched between lower portions of the supporting plates 25. The through holes 256 of the supporting plates 25 align with the screw holes 221 of the bottom plate 22. The mounting member 52 is placed between the supporting plates 25, with the connecting portion 526 facing upward. The pins 525 are received in the corresponding guiding slots 253, and the positioning plate 522 is parallel to the bottom plate 22. A plurality of screws extends through the through holes 256 of the supporting plates 25, to be screwed into the corresponding screw holes 221.

FIG. 4 shows that in use, the electrostatic gun 300 is supported on the positioning plate 522 and between the connecting portion 526 and the latching hole 527. A second end of the band 53 is attached to a top of the electrostatic gun 300, to latch in the latching hole 527 of the positioning plate 522. Therefore, the electrostatic gun 300 is mounted on the positioning plate 522. A combination of the electrostatic gun 300 and the positioning assembly 50 is moved rearward, with the pins 525 sliding along the corresponding guiding slots 253, until the pins 525 are received in the corresponding connecting slots 255. The pins 252 are slid along the corresponding connecting slots 225, to adjust the height of the perpendicular distance between the electrostatic gun 300 and the bottom plate 22. When the height is proper, the positioning assembly 50 is pushed forward, the pins 525 are slid in the corresponding guiding slots 253.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An electrostatic gun supporting apparatus, comprising:
a bracket comprising a bottom plate and two supporting plates perpendicularly extending up from two opposite sides of the bottom plate; and
a positioning assembly comprising a positioning plate for mounted an electrostatic gun, and two pins protruding out from two opposite sides of the positioning plate;
wherein the supporting plates defines two opposite guiding portions, each guiding portion comprises a plurality of guiding slots, the plurality of guiding slots of each guiding portion are parallel to and spaced from one another, the plurality of guiding slots of each guiding portion are arrayed along a direction perpendicular to the bottom plate, the plurality of guiding slots of each guiding portion are communicated with one another, the pins of the positioning assembly can be slidably received in two corresponding ones of the guiding slots respectively form the two opposite guiding portions.

2. The electrostatic gun supporting apparatus of claim 1, wherein each guiding portion further comprises a connecting slot positioning at a rear side of the plurality of guiding slots, the connecting slot communicates with the plurality of guiding slots, the pins are operable of being moved from the two corresponding ones of the guiding slots to another two corresponding ones of the guiding slots via the connecting slots.

3. The electrostatic gun supporting apparatus of claim 1, wherein the positioning assembly further comprises two flanges extending up from two opposite sides of the positioning plate, the pins protrude out from the flanges.

4. The electrostatic gun supporting apparatus of claim 3, wherein the positioning assembly further comprises a band, a connecting portion extends up from one side of the positioning plate, an opposite side of the positioning plate defines a latching hole, a first end of the band is connected to the connecting portion, and a second end of the band is attached to a top of the electrostatic gun to latch in the latching hole.
